(19) United States
(12) Patent Application Publication
(10) Pub. No.: US 2015/0095494 A1
(43) Pub. Date: Apr. 2, 2015

(54) Server Selection

(71) Applicants: Qun Yang Lin, Beijing (CN); Jun Qing Xie, Beijing (CN); Zhi-Yong Shen, Beijing (CN)

(72) Inventors: Qun Yang Lin, Beijing (CN); Jun Qing Xie, Beijing (CN); Zhi-Yong Shen, Beijing (CN)

(21) Appl. No.: 14/398,866

(22) PCT Filed: May 11, 2012
(86) PCT No.: PCT/CN2012/075362

§ 371 Date: Nov. 4, 2014

(51) Int. Cl. G06F 9/50

(52) U.S. Cl. CPC G06F 9/5083
USPC 709/225; 709/235

(57) ABSTRACT

Systems (360), methods (240), and machine-readable and executable instructions (368) are provided for selecting a server. Server selection can include receiving a first query (114 and 242) at a management server (106) from a local server (104). Server selection can also include triggering a reply race (116, 244) by sending a number of query notifications from the management server (106) to a number of actor servers (108-1, 108-2, and 108-3), wherein each of the number of actor servers (108-1, 108-2, and 108-3), in response to receiving the query notifications (116), sends a response (118) to the local server (104) and wherein a first actor server (108-1) from the number of actor servers (108-1, 108-2, and 108-3) is selected (120) by the local server (104). Server selection can further include resolving, at the management server (116), future queries (246) from the local server by referencing a first report that was received (126) from the first actor server.

### BACKGROUND

Load balancing can include the distribution of a workload across multiple computer systems or computer clusters. A computer system and a computer cluster can include an application, e.g., web application, server and a cluster of application servers, respectively. Clusters of application servers can include redundant application servers and redundant application servers can include multiple copies of the same application or content. An application hosting workload can be load balanced across multiple clusters of application servers, i.e., multiple clusters of redundant application servers. Clusters of application servers can be physically located at a number of locations. Establishing the shortest path between a user and an application server can include a number of metrics which can affect application hosting performance.

### BRIEF DESCRIPTION OF THE DRAWINGS

FIG. 1 illustrates a diagram of server selection according to the present disclosure.

FIG. 2 is a flow chart illustrating an example of a method for selecting a server according to the present disclosure.

FIG. 3 illustrates a block diagram of an example of a machine-readable medium in communication with processing resources for server selection according to the present disclosure.

### DETAILED DESCRIPTION

Examples of the present disclosure may include methods and systems for server selection. An example method for selecting a server may include receiving a first query at a management server from a local server and triggering a reply race by sending a number of query notifications from the management server to a number of actor servers, and selecting a first actor server. Furthermore, an example method for selecting a server may further include resolving, at the management server, future queries from the local server by referencing a first report that was received from the first actor server.

In some examples of the present disclosure, a server from a number of replicated servers deployed at a number of locations can be selected. The selection can be based on the shortest propagation delay from a querying server to an application server. An application server can include a number of types of servers that respond to information requests. For example, an application server can include a content server or an application server, although a server is not limited to a content server or an application server. A querying server can include a server that assists in resolving a host name into an Internet Protocol (IP) address for a client. For example, a querying server can include a Domain Name System (DNS) server, however, a querying server is not limited to a DNS server and can include servers that accommodate other convention for resolving host names.

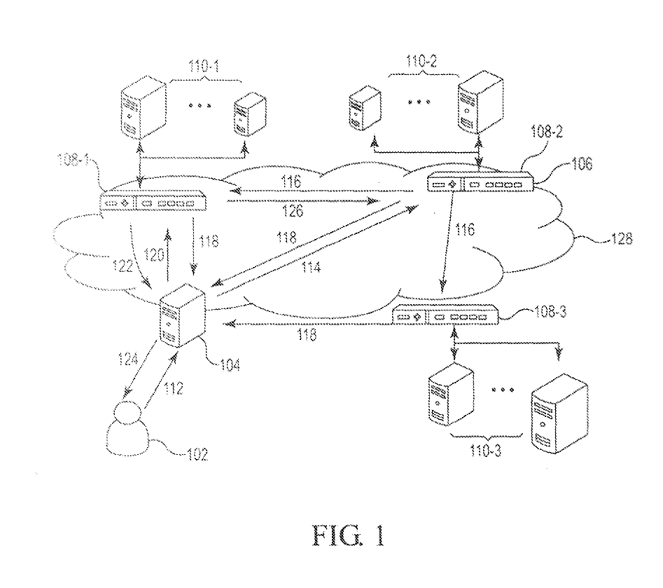

FIG. 1 illustrates a diagram of server selection according to the present disclosure. In some examples of the present disclosure, a local server 104 can resolve a DNS query on behalf of a client 102. A client 102 can include any device that needs to resolve a DNS query. For example, a client 102 can include a desktop personal computing system or a mobile computing system, although a client 102 is not limited to the same. A local server 104 can include a computing device that can facilitate the resolution of a host name into an Internet Protocol address. For example, a server 104 can include a DNS server. Furthermore, a local server 104 can include a DNS server that is designated to resolve DNS queries for client 102. Local server 104 can be local to client 102 because local server 104 is designated to resolve DNS queries for client 102. That is, local server 104 is not limited to DNS servers that are spatially located in proximity to client 102.

In some examples of the present disclosure, an intercepting network device can allocate workload to a number of application servers. An intercepting network device can include any device that intercepts traffic, e.g., network traffic, and forwards the traffic to one of a number of servers, e.g., an application server, a content server, and so on. For example, an intercepting network device can include an application delivery controller. An application delivery controller can intercept requests and deliver the requests to one of a number of application servers or content servers. Delivery of requests can include balancing the workload of a number of application servers.

A number of application delivery controllers can be connected via the internet 128. A workload can be distributed among the number of application delivery controllers. An application delivery controller can include a global load balancer (GLB). A GLB can function as a manager or as an actor such that a management GLB can distribute a workload to a number of actor GLBs. For example, a management GLB 106 can distribute a workload to a first actor GLB 108-1, to a second actor GLB 108-2, and to a third actor GLB 108-3 (referred to generally as actor GLB's 108). In a number of examples of the present disclosure, a management GLB 106 can function as an actor GLB 108-2. The actor GLB's 108 can distribute a workload to a number of application servers. For example, actor GLB 108-1 can distribute a workload to a first number of application servers 110-1, actor GLB 108-2 can distribute a workload to a second number of application servers 110-2, and actor GLB 108-3 can distribute a workload to a third number of application servers 110-3 (referred to generally as application servers 110).

A management GLB 106 and a number of actor GLBs 108 can be synchronized. For example, a management GLB 106 and an actor GLB 108-1 can be time synchronized, a management GLB 106 and an actor GLB 108-2 can be time synchronized, and a management GLB 106 and an actor GLB 108-3 can be time synchronized. Time synchronization can be achieved by a number or means and is not limited to a single method. For example, time synchronization can be achieved by using a Network Time Protocol (NTP) server or a Global Position System (GPS). Time synchronization can allow a local server to select an actor GLB with the shortest delay to the local server by providing for an accurate comparison between the delays from a number of actor GLBs to the local server.

In some examples of the present disclosure, client 102 can send a DNS query 112 to a local server 104. A local server 104 in resolving a domain name to an IP address can be directed to a management GLB 106. The local server 104 can send the DNS query 114 that the local server 104 received from the client 102 to a management GLB 106. In response to receiving the DNS query 114, a management GLB 106 can trigger a reply race among the actor GLBs 108 that the management GLB 106 manages.

A reply race can include a means of selecting an actor GLB. A management GLB 106 can forward a DNS query that it received from a local server 104 to each of the actor GLB's 108. For example, the management GLB 106 can forward a DNS query 116 to an actor GLB 108-1, the management GLB 106 can forward a DNS query 116 to an actor GLB 108-2 where the management GLB 106 can also function as an actor GLB 108-2, and the management GLB 106 can forward a DNS query 116 to an actor GLB 108-3.

In a number of examples of the present disclosure a management GLB 106 can send a number of query notifications to each of the actor GLB's 108. A query notification can include a private message that includes a transaction ID, the IP address of the local server 104, the IP address of the management GLB 106, and a penalty delay value. Furthermore, a query notification can include a other information related to a local server 104, a number of actor GLB's 108, a management GLB 106, and the private message.

In some examples of the present disclosure, a management GLB 106 can calculate a penalty delay value for each of the actor GLBs 108 based on the load of the application servers 110 that corresponds to each of the actor GLB's 108 and on a one-way propagation delay to each of the actor GLBs 108. A propagation delay can include the time that it takes for a message to be sent from a first server to a second server. A message can include any number of communication formats and/or signals that travel from a first server to a second server. For example, a management GLB 106 can calculate a first penalty delay value for an actor GLB 108-1. The first penalty delay value can correspond to the workload on the application servers 110-1 and the one-way propagation delay from the management GLB 106 to the actor GLB 108-1 or from the actor GLB 108-1 to the management GLB 106. A management GLB 106 can calculate a second penalty delay value for an actor GLB 108-2. The second penalty delay value can correspond to the workload on the application servers 110-2 and the one-way propagation delay from the management GLB 106 to the actor GLB 108-2 or from the actor GLB 108-2 to the management GLB 106. A management GLB 106 can calculate a third penalty delay value for an actor GLB 108-3. The third penalty delay value can correspond to the workload on the application servers 110-3 and the one-way propagation delay from the management GLB 106 to the actor GLB 108-3 or from the actor GLB 108-3 to the management GLB 106. The examples used herein are illustrative and can include any number of criteria for determining a propagation delay value.

A management GLB 106 can calculate a penalty delay value by calculating a workload penalty value. To calculate a workload penalty value a management GLB 106 can receive a number of updates from the agent GLB's 108. The updates can include an update on the load of the application servers 110. For example, an actor GLB 108-1 can send an update to a management GLB 106 that includes an update on the load of the application servers 110-1. An actor GLB 108-2 can send an update to a management GLB 106 that includes an update on the load of the application servers 110-2. An actor GLB 108-3 can send an update to a management GLB 106 that includes an update on the load of the application servers 110-3. The management GLB 108 can receive each of the updates and determine a different penalty delay value for each of the actor GLBs 108. Examples of the present disclosure can include a number of mappings between the load of the application servers 110 and a penalty delay value and are not limited to particular functions, transformations, or mappings.

The updates can be activated by a number of criteria. For example, updates can be scheduled at regular intervals or can be event driven. Furthermore, the updates can be reported in a push or pull mode and the updates can follow any format. The updates can include a number of elements that are associated with an actor GLB and a number of application servers that are associated with the actor GLB as well as elements that are associated with a management GLB.

In a number of examples of the present disclosure a management GLB 106 can calculate a penalty delay value for each of the actor GLBs 108 based on a one-way propagation delay to each actor GLBs 108 and the actor GLBs 108 can add a workload delay value to the penalty delay value, the workload delay value can be based on the load of the application servers 110. For example, a management GLB 106 can calculate a first penalty delay value for an actor GLB 108-1. The penalty delay value can include a one-way propagation delay from the management GLB 106 to the actor GLB 108-1 or a one-way propagation delay from the actor GLB 108-1 to the management GLB 106. A second penalty delay value for an actor GLB 108-2 can include a one-way propagation delay from the management GLB 106 to the actor GLB 108-2 or a one-way propagation delay from the actor GLB 108-2 to the management GLB 106. A penalty delay value for an actor GLB 108-3 can include a one-way propagation delay from the management GLB 106 to the actor GLB 108-3 or a one-way propagation delay from the actor GLB 108-3 to the management GLB 106.

After receiving the penalty delay value from the management GLB 106 the actor GLBs 108 can add a workload delay value to the penalty delay value. For example, an actor GLB 108-1 can add a workload delay value to the penalty delay value. The workload delay value can be based on the load of the application servers 110-1. An actor GLB 108-2 can add a workload delay value to the penalty delay value. The workload delay value can be based on the load of the application servers 110-2. An actor GLB 108-3 can add a workload delay value to the penalty delay value. The workload delay value can be based on the load of the application servers 110-3. Examples of the present disclosure can include a number of mappings between the load of the application servers 110 and a workload delay value and are not limited to particular functions or transformations.

A replay relay race can further include the actor GLB's 108 waiting a time value equal to the penalty delay value and sending a spoofed response 118 to the local server 104. Sending a spoofed response 118 can include sending a spoofed Canonical Name (CNAME) response or a Name Server (NS) response. A spoofed response can include a DNS response that can be sent on behalf of an arbitrary IP address to a local DNS server. The spoofed response can delegate an actor GLB that sent the response to resolve a domain name. For example, an actor GLB 108-1 can wait a time value equal to a first penalty delay value and then send a spoofed response 118, delegating actor GLB 108-1 to resolve the domain name, to the local server 104. An actor GLB 108-2 can wait a time value equal to a penalty delay value and then send a spoofed response 118, delegating actor GLB 108-2 to resolve the domain name, to the local server 104. An actor GLB 108-3 can wait a time value equal to a penalty delay value and then send a spoofed response 118, delegating actor GLB 108-3 to resolve the domain name, to the local server 104.

Moreover, a replay relay race can include the local server 104 selecting an actor GLB. The local server 104 can select an actor GLB by waiting for a spoofed response after sending a DNS query 114 to a management GLB 106 and by selecting the first spoofed response that the local server 104 receives and ignoring the spoofed responses that are received after the first spoofed response is received. The duplicate spoofed responses received after the first spoofed response is received can be dropped by the local server 104. The local server 104 can select the actor GLB that sent the first spoofed response. That is, the local server 104 can select the actor GLB that is delegated to resolve a domain name in the first spoofed CNAME response or in the first spoofed NS response. For example, the local server 104 can select an actor 108-1 if the first spoofed response delegated actor 108-1 to resolve a domain name.

After receiving the first spoofed response, a local server 104 can send a new DNS query 120 to a selected actor GLB 108-1. A new DNS query can function to get the IP address of the application server 110-1 which is considered to be the application server with the shortest delay to the local server 104. A selected actor GLB 108-1 can resolve a domain name 122 with the IP address of an application server 110-1 upon receiving the new DNS query. Local server 104 can receive the IP address 122 of an application server 110-1 and send the IP address 124 to the client 102.

In some examples of the present disclosure, a selected actor GLB 108-1 can report a round trip time (RTT) 126 to a management GLB 106. RTT can function to measure the latency between an actor GLB 108-1 and a local server 104 by measuring the latency from an actor GLB 108-1 to a local server 104 and by measuring the latency from a local server 104 to an actor GLB 108-1. A RTT can include the time between when the actor GLB 108-1 sends a spoofed response 118 to a local server 104 and when the actor GLB 108-1 receives a new DNS query 120.

In a number of examples of the present disclosure, a management GLB 106 can receive a number of RTT reports over a period of time. That is, a management GLB 106 can receive a number of DNS queries from a number of local servers over a period of time and trigger a number of reply races in response to receiving a number of DNS queries over a period of time. The management GLB 106 can receive a number of RTT reports over a period of time in response to triggering a number of reply races. After receiving a number of RTT reports, a management GLB 106 can resolve DNS queries from a local server 104 if a management GLB 106 previously received a DNS request from the local server 104 during a period of time. The management GLB 106 can resolve DNS requests by referencing a number of RTT reports. For example, a management GLB 106 can resolve a DNS query by selecting an actor GLB with the lowest RTT from the number of received RTT reports and/or with the lowest application server load. Resolving future DNS queries by referencing a number of RTT reports can provide for a faster resolution of a domain name than a resolution that does not reference a number of RTT reports because a reply race does not have to be instantiated every time a DNS query is received when a number of RTT reports are referenced. The number of RTT reports can function as historical data for a predefined period. For example historical data can include RTT reports that are received on a per day basis, or a per week basis. However, historical data is not limited to a specific time interval or a specific time and date.

In resolving a DNS query a management GLB 106 can select an actor GLB based on a number of factors which incorporate a number of RTT reports. For example, a management GLB 106 can select an actor GLB 106 with the highest frequency. An actor GLB 106 with the highest frequency can include an actor GLB 106 with the highest frequency of RTT reports in a number of RTT reports. Furthermore, a management GLB 106 can select an actor GLB 106 with the highest frequency and lowest weighted RTT. Weighing a RTT can include modifying a RTT by multiplying the RTT with a factor such as day of time or application server load. The selection process can include a number of methods for selecting an actor GLB and is not limited to the examples presented herein.

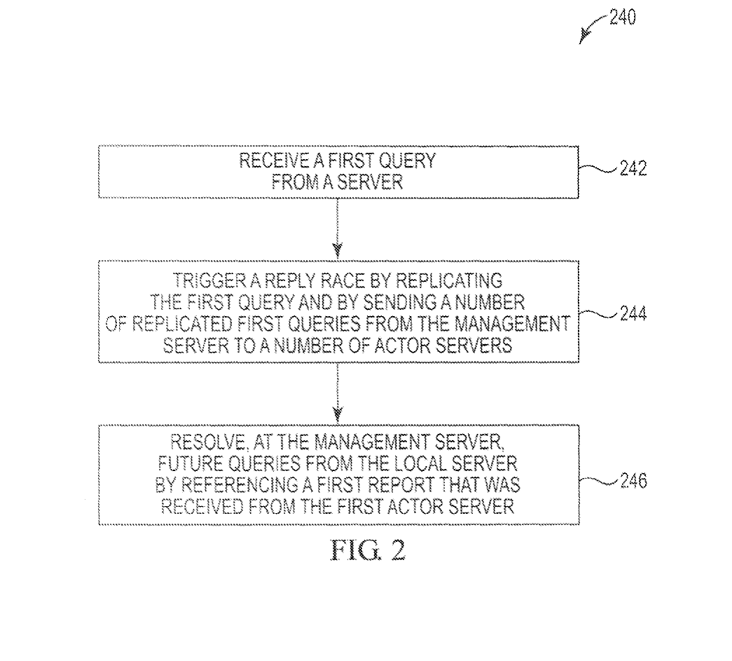

FIG. 2 is a flow chart illustrating an example of a method for selecting a server according to the present disclosure. The method 240 can select a server by triggering a reply race. The method 240 can select future servers by referencing a number of reply races.

At 242, a first query is received from a server. A server can include a DNS server. A first query can include a DNS query that functions to resolve a domain name. The first query can be received at a management server. A management server can include a management GLB that intercepts traffic sent to a number of application servers and/or content servers and directs the traffic to a number of actor GLBs. For example a management server can intercept traffic that is directed to a number of application servers such that the application server hosts a website.

At 244, the management server triggers a reply race. A reply race can be triggered by replicating the first query and by sending a number of replicated first queries from the management server to a number of actor servers. A reply race can also be triggered by sending a number of query notifications to a number of actor servers. The query notifications can include a private message that includes a transaction ID, the IP address of the local server, the IP address of the management GLB, and a penalty delay value. An actor server can include an actor GLB that intercepts traffic to a number of application servers and/or content servers and distributes that traffic to an application server and/or content servers. Each of the actor servers can create a spoofed response to the DNS query and send it to a local server. The spoofed response can delegate the actor server that sent the spoofed response to resolve a domain name. The local server can select a first actor server by selecting a first spoofed response received and identifying the actor server that sent the spoofed response. A local server can then send a new query to an actor server that sent a spoofed response that was received first. The new query can function to resolve a domain name. The first actor server can resolve a domain name by selecting an application server that the first actor server intercepts traffic for. The first actor server can then report a RTT to a management server. The report of a RTT can function as a first report. RTT can include the time between when the first actor server sent the spoofed response and the time when the first actor server received a new query from the local server.

At 246, a management server can resolve future queries from the local server by referencing a first report that was received from the first actor server. In some examples of the present disclosure a management server can resolve future queries from a local server by referencing a number of RTT reports received over a period of time. A period of time can include a day, a week, or any number of time periods. For example a period of time can include the time covering the last report received. A number of RTT reports can include a number of RTT reports that are received over a period of time. For example, a number of RTT reports can include a number of RTT reports received in a day, in a week, or the RTT reports received in any number of periods of time.

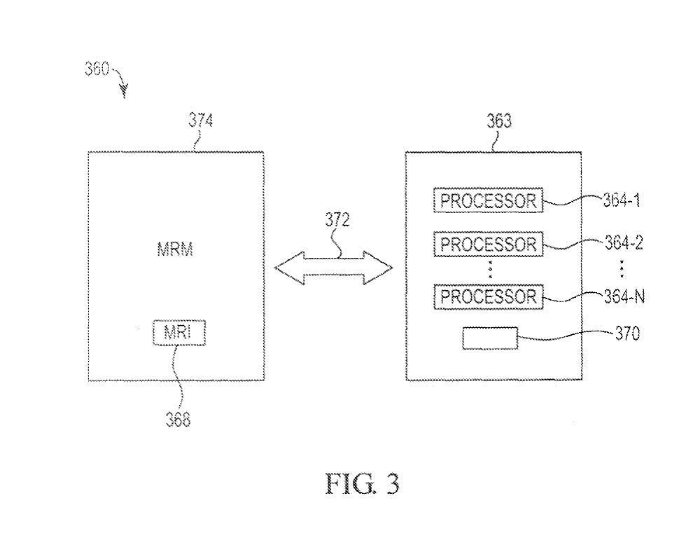

FIG. 3 illustrates a block diagram 360 of an example of a machine-readable medium (MRM) 374 in communication with processing resources 364-1, 364-2 . . . 364-N for server selection according to the present disclosure. MRM 374 can be in communication with a computing device 363 (e.g., an application server, having processor resources of more or fewer than 364-1, 364-2 . . . 364-N). The computing device 363 can be in communication with, and/or receive a tangible non-transitory MRM 374 storing a set of machine readable instructions 368 executable by one or more of the processor resources 364-1, 364-2 . . . 364-N, as described herein. The computing device 363 may include memory resources 370, and the processor resources 364-1, 364-2 . . . 364-N may be coupled to the memory resources 370.

Processor resources 364-1, 364-2 . . . 364-N can execute machine-readable instructions 368 that are stored on an internal or external non-transitory MRM 374. A non-transitory MRM, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), flash memory, etc., as well as other types of machine-readable media.

The non-transitory MRM 374 can be integral, or communicatively coupled, to a computing device, in either in a wired or wireless manner. For example, the non-transitory machine-readable medium can be an internal memory, a portable memory, a portable disk, or a memory associated with another computing resource (e.g., enabling the machine-readable instructions to be transferred and/or executed across a network such as the internet).

The MRM 374 can be in communication with the processor resources 364-1, 364-2 . . . 364-N via a communication path 372. The communication path 372 can be local or remote to a machine associated with the processor resources 364-1, 364-2 . . . 364-N. Examples of a local communication path 372 can include an electronic bus internal to a machine such as a computer where the MRM 374 is one of volatile, non-volatile, fixed, and/or removable storage medium in communication with the processor resources 364-1, 364-2 . . . 364-N via the electronic bus. Examples of such electronic buses can include Industry Standard Architecture (ISA), Peripheral Component Interconnect (PCI), Advanced Technology Attachment (ATA), Small Computer System Interface (SCSI). Universal Serial Bus (USB), among other types of electronic buses and variants thereof.

The communication path 372 can be such that the MRM 374 is remote from the processor resources (e.g., 364-1, 364-2 . . . 364-N) such as in the example of a network connection between the MRM 374 and the processor resources (e.g., 364-1, 364-2 . . . 364-N). That is, the communication path 372 can be a network connection. Examples of such a network connection can include a local area network (LAN), a wide area network (WAN), a personal area network (PAN), and the Internet, among others. In such examples, the MRM 374 may be associated with a first computing device and the processor resources 364-1, 364-2 . . . 364-N may be associated with a second computing device (e.g., a Java application server).

The processor resources 364-1, 364-2 . . . 364-N coupled to the memory 370 can a receive a first query at a management server from a local server and trigger a reply race by replicating the first query and by sending a number of replicated first queries from the management server to a number of actor servers. The processor resources 364-1, 364-2 . . . 364-N coupled to the memory 370 can resolve, at the management server, future queries from the local server by referencing a first report that was received from the first actor server.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

1. A method for selecting a server comprising:
receiving a first query at a management server from a local server;
triggering a reply race by constructing a number of query notifications and by sending the number of query notifications from the management server to a number of actor servers, wherein each of the number of actor servers, in response to receiving the number of query notifications, sends a response to the local server and wherein a first actor server from the number of actor servers is selected by the local server; and
resolving, at the management server, future queries from the local server by referencing a first report that was received from the first actor server.

2. The method of claim 1, wherein receiving the first query at the management server from the local server includes receiving a first Domain Name System (DNS) query at a global load balancing (GLB) management server and wherein sending the number of query notifications from the management server to the number of actor servers includes sending the number of query notifications from a GLB management server to a number of GLB actor servers, the number of query notifications including a notification identifier, an IP address of the local server, an IP address of the GLB management server and a penalty delay value.

3. The method of claim 1, wherein referencing the first report includes:
triggering a number of reply races over a period of time;
receiving a number of reports from a number of selected actor servers;
selecting a second report from the number of received reports that has a shortest delay; and
selecting a second actor server that is associated with the second report.

4. The method of claim 1, wherein constructing a number of query notifications includes:
creating a number of query notifications that are directed at the number of actor servers; and
calculating a penalty delay value at the management server for each of the number of actor servers, wherein the penalty delay values for each of the number of actor servers is associated with a load on each of the number of actor servers or a load on a number of application servers that are associated with the number of actor servers.

5. The method of claim 1, wherein selecting the first actor server from the number of actor servers includes the local server selecting a first response received from the number of actor servers and selecting the first actor server that sent the first response received.

6. The method of claim 5 wherein receiving the first report includes receiving a selection result and a round trip time and wherein round trip time includes the time from which the first actor server sends the response to the local server to the time in which the first actor server receives a second query from the local server.

7. A non-transitory computer-readable medium storing instructions for server selection executable by a computer to cause a computer to:
receive at a number of actor servers a replicated first query to resolve a domain name from a management server wherein the management server sent the replicated first query in response to receiving a first query to resolve the domain name from a local server;
wait a time period equal to a penalty delay before the number of actor servers send a number of responses to the local server, each response delegating an actor server that sent the response to resolve the domain name;
receive at a first actor server from the number of actor servers a second query from the local server, the second query selecting the first actor server as having a shortest delay to resolve a domain name;
report a round trip time (RTT) and an identification of the first actor server to the management server, the RTT including the time between the first actor server sending the response to the local server and the first actor server receiving the second query from the local server, the management server using the round trip time to make future selections.

8. The medium of claim 7, wherein sending the number of responses to the local server includes sending a number of Canonical Name (CNAME) responses.

9. The medium of claim 7, wherein sending the number of responses to the local server includes sending a number of Name Server (NS) responses.

10. The medium of claim 7, wherein the penalty delay is calculated by the number of actor servers and includes a time delay that corresponds to a load on the number of actor servers or a load on a number of application servers that are associated with the number of actor servers.

11. The medium of claim 7, wherein waiting the time period equal to the penalty delay includes a time synchronization between the number of actor servers and the management server.

12. The medium of claim 7, wherein the round trip time is used by the management server in selecting future actor servers.

13. A server selection system, comprising:
a processing resource in communication with a computer readable medium, wherein the computer readable medium includes a set of instructions and wherein the processing resource is designed to execute the set of instructions to:
receive a first query at a management server from a local server;
replicate the first query at the management server;
trigger a reply race by sending a number of replicated first queries from the management server to a number of actor servers, wherein the number of actor servers, in response to receiving the number of replicated queries, sends a number of responses to the local server;
receive a report at the management server from a selected actor server, the report including:
a round trip time (RTT), wherein the (RTT) includes a time between the selected actor server sending a selected response to the local server and the selected actor server receiving a second query from the local server;
an identification of the selected actor server; and
resolve future queries sent from the local server to the management server by referencing the received reports and a load on the number of actor servers or a load on a number of actor servers associated with the number of actor servers.

14. The system of claim 12, wherein sending the number of replicated first queries includes sending a time penalty, the time penalty being determined by a load of the number of actor servers and a load on a number of application servers associated with the number of actor servers and a one-way propagation delay from the management server to the number of actor servers.

15. The system of claim 13, wherein the time penalty is determined by the management server, the management server receiving a number of updates from the number of actor servers, the number of updates including the load of the number of actor servers and the load of a number of application servers associated with the number of actor servers.
